(19) United States
(12) Patent Application Publication
(10) Pub. No.: US 2006/0143065 A1
(43) Pub. Date: Jun. 29, 2006

(54) Apparatus and method for automatically managing and performing schedule

(75) Inventors: Han-Na Lim, Siheung-si (KR); Jun-Hwan Kim, Seoul (KR); Bong-Kyo Moon, Yongin-si (KR); Ki-Ho Jung, Gwacheon-si (KR); Jong-Hyo Lee, Pyeongtaek-si (KR); Eun-Taek Lim, Suwon-si (KR); Ju-Yeon Song, Seoul (KR)

Correspondence Address: DILWORTH & BARRESE, LLP, 333 EARLE OVINGTON BLVD., UNIONDALE, NY, 11553, US

(73) Assignee: Samsung Electronics, Co., Ltd.

(21) Appl. No.: 11/321,558

(22) Filed: Dec. 29, 2005

(30) Foreign Application Priority Data
Dec. 29, 2004 (KR) 115372/2004

(51) Int. Cl. G06F 15/02

(52) U.S. Cl. 705/9

(57) ABSTRACT

A method for managing user schedules, which includes inputting data; determining if the input data corresponds to schedule data or request data; extracting a function necessary for executing an action which a user must perform at a specific time for the schedule data or the request data; determining a main element type according to the extracted function; and storing the input data when the input data correspond to the schedule data according to the main element type, and executing the extracted function and outputting results obtained by executing the extracted function when the input data correspond to the request data.

### PRIORITY

This application claims priority to an application filed in the Korean Intellectual Property Office on Dec. 29, 2004 and assigned Serial No. 2004-115372, the contents of which are incorporated herein by reference.

### BACKGROUND OF THE INVENTION

1. Field of the Invention

The present invention relates to an apparatus and method for managing and performing schedules, and more particularly for managing schedules, which structurally classify and analyze user input or data transferred to users, and output specific information when corresponding events occur.

2. Description of the Related Art

With the development of telephones, mail, the Internet, traffic systems, etc., modern person directly or indirectly has contact with other many persons. Further, since modern person has contact with numerous sources of information directly or indirectly which may relate to oneself each day, modern person must individually and increasingly expend effort and time in order to extract personally relevant information from the numerous sources of information and utilize the extracted information. Accordingly, various schemes have been proposed, which can efficiently organize schedules by systematically managing and utilizing information.

A general schedule management means may include electronic notebooks, Personal Digital Assistants (PDAs) or organizers installed in cell phones. In the case of an electronic notebook or a PDA, a user registers schedules by using an input tool on the electronic notebook or PDA. A schedule program, managed by user input, displays information input at corresponding times and relating to time factors.

Hereinafter, a general method for performing schedule management in a schedule management means will be described with reference to FIG. 1. FIG. 1 shows a diagram illustrating a typical calendar displayed on the schedule management means for schedule input and management.

Referring to FIG. 1, in general schedule input, work to be performed is simply classified by corresponding dates or time and is then input in a text form. For example, a user of a PDA selects a desired date and time from a calendar output to a PDA display window, and inputs the desired schedule content by using various input means.

Specifically, as illustrated in FIG. 1, when the PDA user must input a schedule of “lunch appointment with assistant manager Mr. Kim at 12:00 on Nov. 5, 2004,” the PDA user touches November 5 on the calendar displayed on the touch screen using a PDA stylus pen. Then, a screen requiring input of a schedule corresponding to November 5 is displayed. Accordingly, the PDA user inputs the schedule on the display screen by using the PDA stylus pen, or other input means. Then, the PDA reports the input schedule content to the user at a specific preset time.

The prior art as described above causes the following problems. First, an input method is restricted to a primitive level which requires direct user input. That is, when the user inputs schedules to the PDA, the user must input the schedules in a text form by using a PDA stylus pen.

Next, the conventional schedule management function provides a simple alarm according to input schedules. For example, in the case of a schedule of “business meeting at 2:00 P.M on 3, 2004” a user hears an alarm from the schedule management function at corresponding time or preset time. Accordingly, the user recognizes the necessity of the health examination result confirmation at the corresponding time, and confirms the health examination result by calling a hospital or connecting to the Internet.

Lastly, when the user wants to search for a specific schedule from among the stored schedules, the user must directly search for and perform a specific function of the specific schedule. For example, when the user only wants to see a “meeting” of given day's schedules, the user must visually check all the day's stored schedules, or must directly search for a meeting schedule through a word filtering function.

### SUMMARY OF THE INVENTION

Accordingly, the present invention has been made to solve the above-mentioned problems occurring in the prior art, and it is an object of the present invention to provide an apparatus and a method for managing and performing schedules, in which the schedules are input through various input means.

It is another object of the present invention to provide an apparatus and a method for managing and performing input schedules, in which the schedules are structurally and efficiently managed according to the input of the schedules. It is further another object of the present invention to provide an apparatus and a method for managing and performing schedules, in which the schedules are output in various ways according to the classification of the schedules.

In order to accomplish the aforementioned object, according to one aspect of the present, there is provided a method for managing user schedules, the method including inputting data; determining if the input data correspond to schedule data or request data; extracting a function necessary for executing an action which a user must perform for the schedule data or the request data at a specific time point; determining a predetermined main element type according to the extracted function; and storing the input data when the input data correspond to the schedule data according to the determined main element type, and executing the extracted function and outputting results obtained by executing the extracted function when the input data correspond to the request data.

In order to accomplish the aforementioned object, according to another aspect of the present, there is provided an apparatus for managing user schedules, the apparatus including an input unit for receiving data relating to the user schedules from input means, determining if the data correspond to schedule data or request data, extracting a function necessary for executing an action which a user must perform for the schedule data or the request data at a specific time point, determining a predetermined main element type according to the extracted function, storing the data when the input data correspond to the schedule data according to the determined main element type, and executing the extracted function and outputting the request data in order to execute the extracted function when the data correspond to the request data; an execution unit for classifying functions according to a main element of the output request data, executing the classified functions, and outputting results obtained by executing the classified functions; and an output unit for receiving the results from the execution unit and displaying the received results.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a typical calendar displayed on a schedule management means in schedule input and management;

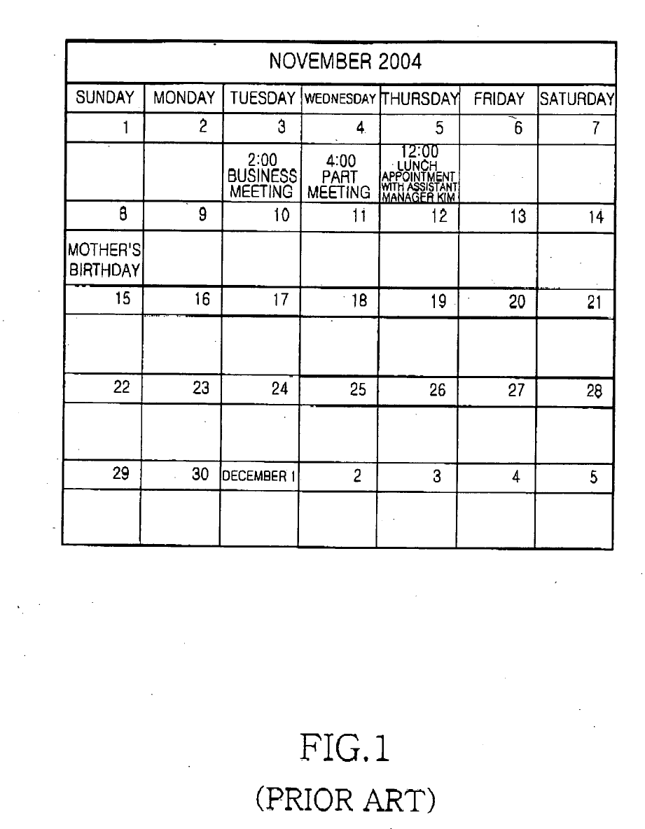

FIG. 2 is a block diagram illustrating the construction of the smart organizer constructed as a functional module in a specific terminal;

FIG. 3 is a diagram illustrating various methods by which data are input to a smart organizer according to an embodiment of the present invention;

FIG. 4 is a block diagram illustrating the construction of a smart organizer according to an embodiment of the present invention;

FIG. 5 is a flow diagram illustrating a processing process when data are input to a smart organizer according to an embodiment of the present invention;

FIG. 6 is a flow diagram illustrating a process in which an event/action extraction unit processes input data according to a preferred embodiment of the present invention;

FIG. 7 is a flow diagram illustrating a processing procedure when an event occurs in a schedule according to an embodiment of the present invention; and

FIG. 8 is a diagram illustrating a structure of a main element according to an embodiment of the present invention.

### DETAILED DESCRIPTION OF THE PREFERRED EMBODIMENT

A preferred embodiment of the present invention will be described in detail herein below with reference to the accompanying drawings. In the following description, a detailed description of known functions and configurations incorporated herein will be omitted when it may obscure the subject matter of the present invention.

The present invention proposes an apparatus and a method in which data directly input by a user or information input by other means are automatically classified and analyzed, and a specific action is output in response to a generated event. Hereinafter, a means having a schedule management or execution function proposed by the present invention will be referred to as a smart organizer or simply as an organizer.

Hereinafter, the terms “schedule” and “request”, as used in the present invention, will be described. A “schedule” may be classified into an “event” and an “action”. The “event” denotes time, place and specific states for predetermined execution by a user. An “action” denotes tasks which the user wants to perform at a specific point in time. For example, in the schedule of “lunch_appointment with assistant manager Mr. Kim at 12:00 on Nov. 5, 2004,” the part “12:00 on Nov. 5, 2004” corresponds to the event and the part “lunch appointment with assistant manager Mr. Kim” corresponds to the action.

A “request” denotes an event corresponding to the current point in time. The current point in time may also denote the current time or the current place. For example, since an event of “output of only meetings from stored schedules” requires an action at the current time, the event may correspond to the request.

As described above, a means for performing a series of functions for receiving the “schedule”, structurally and efficiently managing and executing the received schedule through analysis and classification processes, taking proper actions, etc., will be referred to as a smart organizer or an organizer. The smart organizer may also be constructed as an independent apparatus. However, preferably, the smart organizer may also be constructed as a functional module in a portable terminal, a computer, an electronic notebook, etc. Accordingly, the smart organizer proposed by the present invention will be described throughout the present specification putting emphasis on its construction and function, but it is assumed that the smart organizer is constructed as one independent functional module in a personalized apparatus such as an electronic notebook and a portable terminal.

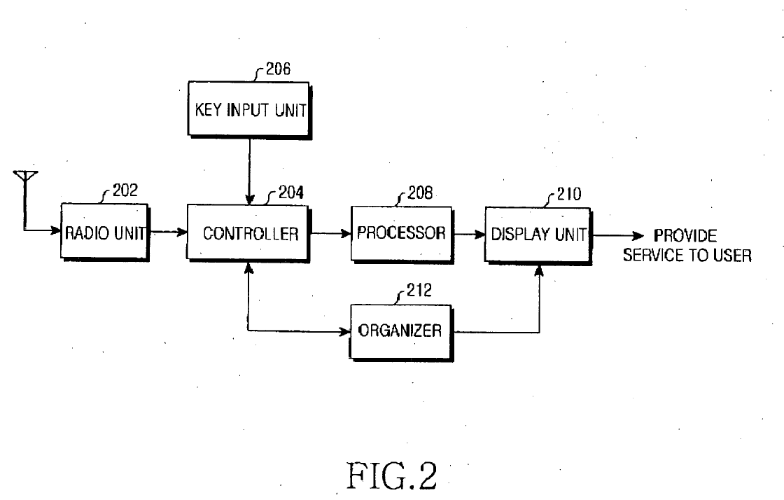

FIG. 2 is a block diagram illustrating the construction of the smart organizer constructed as a functional module in a specific terminal. Referring to FIG. 2, the terminal includes a radio unit 202, a controller 204, a key input unit 206, a processor 208, a display unit 210 and an organizer 212. The radio unit 202 converts radio signals received through an antenna to predetermined signals and transfers the converted signals to the controller 204. When the terminal corresponds to a wire/wireless terminal, the radio unit 202 may also operate as a wire/wireless unit.

The key input unit 206 has a key input structure and includes number keys for dialing and function keys for performing various functions. Further, the key input unit 206 may include a separate function key as the situation requires, and may also employ a touch pad scheme or a virtual input key scheme. The key input unit 206 generates key signals corresponding to keys input by a user and provides the key signals to the controller 204.

The controller 204 controls the general operation of the portable terminal (i.e. an operation relating to a call setup, power control and data transmission/reception). The controller 204 transfers all input data to the organizer 212, thereby controlling the organizer 212 to perform schedule-related operations. The schedule-related operations will be described in more detail below.

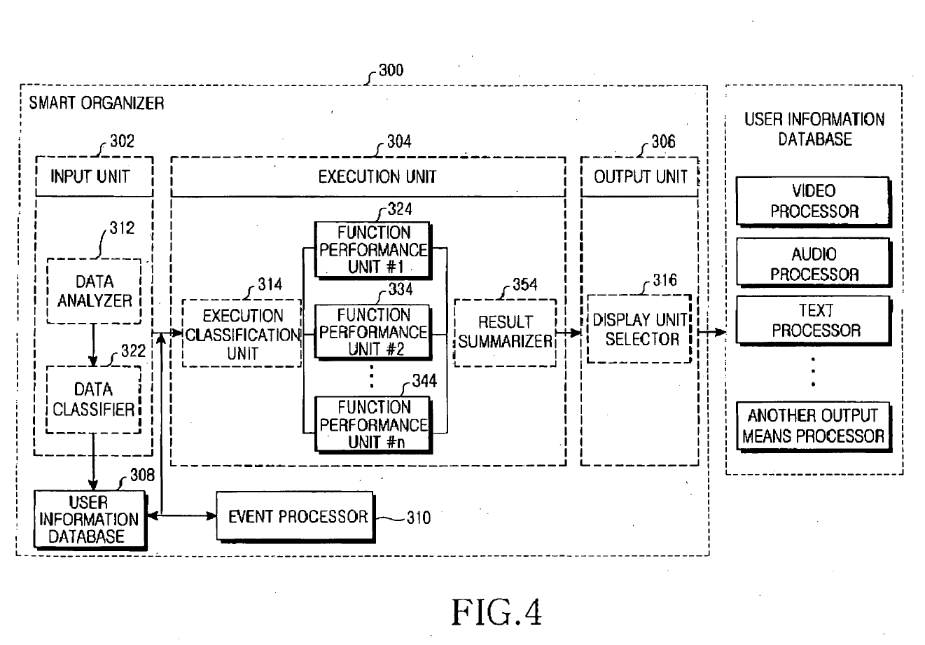

The processor 208 performs an operation for processing a terminated call or a call to be originated. The organizer 212 is realized as the smart organizer according to the present invention, and processes data output from the controller 204. The detailed construction and functions of the smart organizer will be described with reference to FIG. 4. The display unit 210 displays image signals, audio signals, text signals, etc. (output from the processor 208 and the organizer 212), onto a screen or outputs the signals through a speaker so that the user can recognize the displayed signals.

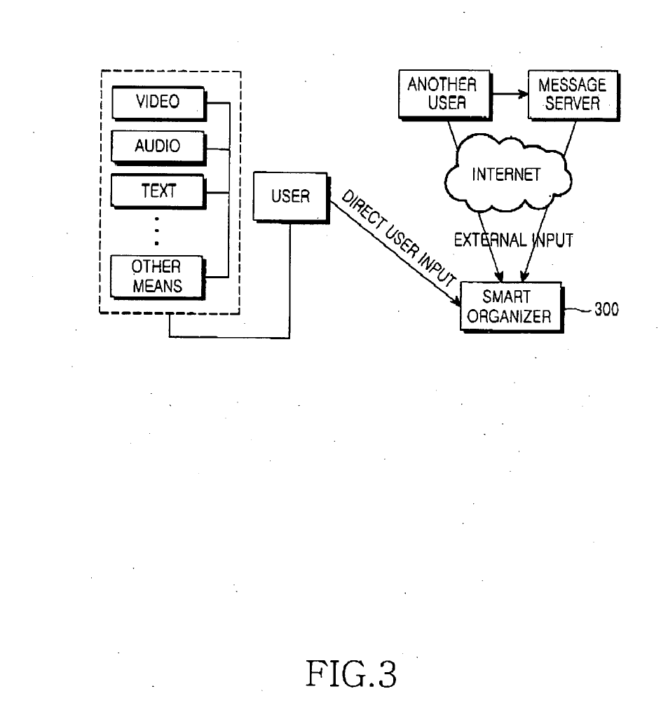

Methods for proving schedule input will now be described. FIG. 3 is a diagram illustrating various methods by which data are input to the smart organizer, according to an embodiment of the present invention. Referring to FIG. 3, the smart organizer 300 may directly receive data from a user or receive external data, such as data transferred from other users and data input through a network. The data directly input from the user may include images, audio, text, etc. That is, in the case of text, the user may input the text through a keypad, etc. In the case of voice, the user may input the voice through a microphone, etc. The input sound signals are converted into electrical signals. In the case of still images or dynamic images, the user may input the still images or dynamic images by using an image acquisition means such as a camera. Among the various types of input data, only information including content related to schedules or requests is significant as input for the smart organizer, while information not including the content relating to the schedules or the requests is not processed as the input for the smart organizer. A description relating to the input of the smart organizer will be given in more detail below.

The external data received in the smart organizer may also be input in various ways. The data may include images, audio, text, etc., similar to the data directly input from the user. That is, the data may be input directly or indirectly to a corresponding smart organizer in a message form by another user. In the case of direct input, a user transmits a message to a unique address of a smart organizer through point-to-point scheme. In the case of indirect input, a service provider may transmit a message through a message server by using a user identifier (e.g. an e-mail address) assigned in advance.

The construction of a smart organizer will now be described. FIG. 4 is a block diagram illustrating the construction of the smart organizer, according to the embodiment of the present invention. Referring to FIG. 4, the smart organizer 300 includes an input unit 302, an execution unit 304, an output unit 306, a user information database 308 and an event processor 310.

The input unit 302 analyzes and classifies input data, and includes a data analyzer 312 and a data classifier 322.

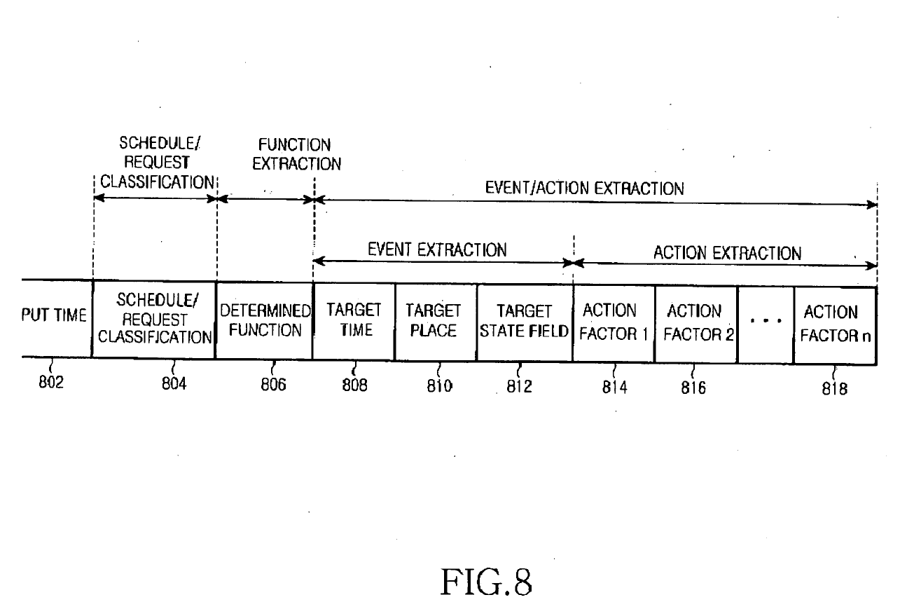

The data analyzer 312 analyzes data input as images, audio, text, etc., and generates main elements as resultants. The main element includes user requirements of input data, i.e. specific words or simple sentences, etc., representing an event and an action. The construction of the main element will be described in more detail with reference to FIG. 8.

Further, the data analyzer 312 may include multiple filters and a main element creator, which may be set by both a user and a service provider. The filters represent a schedule/request determiner, a function extractor, an event extractor and an action extractor. The event extractor and the action extractor may be separated or integrated.

The data classifier 322 detects the main elements of the input data received from the data analyzer 312 and classifies schedules or requests. When the input data correspond to the schedule, the data classifier 322 stores the input data in a user database. When the input data correspond to the request, the data classifier 322 transfers the input data to the execution unit 304 in order to execute a corresponding action.

The execution unit 304 executes corresponding functions according to the main element of each input data received from the input unit 302 in order to process the action requested by the user, and outputs the results of the processing. The execution unit 304 may be classified into an execution classification unit 314, function performance units 324, 334 and 344 for performing multiple functions which can be supported by the smart organizer, and a result summarizer 354 according to its detailed functions.

The execution classification unit 314 recognizes the main element of the of the input data received from the data classifier 322 of the input unit 302, and outputs the input data to the function performance units 324, 334 or 344 which will perform a corresponding function when the input data are input data requiring performance of the specific function.

Functions performed by the function performance units 324, 334 and 344 represent the various kinds of functions supported by the smart organizer, and perform actions according to corresponding functions. For example, the function performance units 324, 334 and 344 can perform a filtering function of specific words or sentences, an e-mail sending function, a Multimedia Messaging Service (MMS) sending function, etc. The function performance units 324, 334 and 344 may also operate together, separately or sequentially as necessary to support functions which must be performed simultaneously.

The result summarizer 354 summarizes results of the functions having been performed or which are to be performed by the function performance units 324, 334 and 344. For example, the result summarizer 354 can receive and summarize results obtained through performance of the specific word filtering action by the specific function performance unit. When the specific function performance unit filters a word “meeting” and outputs the filtering result to the result summarizer 354, the result summarizer 354 summarizes the received result. That is, the result summarizer 354 summarizes and classifies results input from the function performance units 324, 334 and 344.

The output unit 306 determines execution means for optimally displaying resultants received from the result summarizer 354, and outputs the determined result to a display unit of a user terminal.

The user information database 308 receives the data, whose attribute is the “schedule,” classified by the data classifier 322, and stores the received data. The event processor 310 manages events of the main elements and checks if a corresponding event has occurred while communicating with the user information database 308. Specifically, the event processor 310 periodically checks events of the stored schedule (i.e. checks if when/where/in what situation the smart organizer must take action). If the corresponding event has occurred, the event processor 310 outputs the schedule stored in the user information database 308 to the execution unit 304.

For example, a time event may be checked by using a terminal (e.g., a cell phone displaying date and current time, an electronic notebook and a PDA) capable of using a time-related service. A place event may be checked by using a LBS (Location-Based Service). That is, because a terminal having a Global Positioning System (GPS) function can find out the current location, it can determine if the place event has occurred.

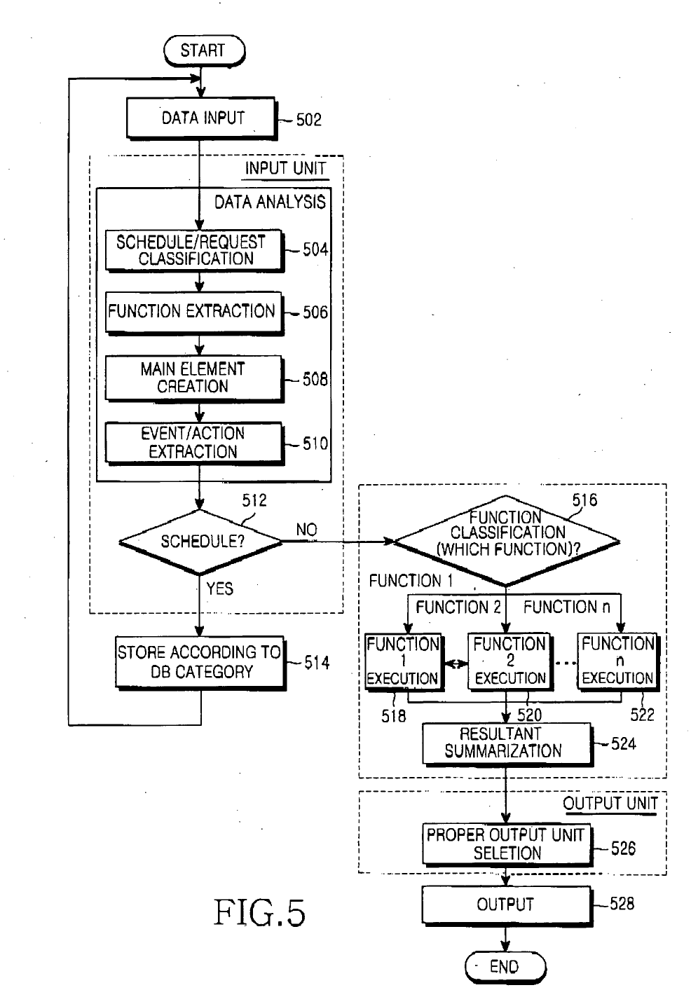

The Operation of the smart organizer will now be described. FIG. 5 is a flow diagram illustrating a processing process when data are input to the smart organizer according to the embodiment of the present invention. Referring to FIG. 5, in step 502, data are input to the smart organizer. Then, steps 504, 506, 508, 510 and 512 represent operations performed by the data analyzer 312 and the data classifier 322 of the input unit 302. In step 504, the data analyzer 312 of the smart organizer determines if the input data correspond to a schedule or a request.

For identification regarding whether the input data correspond to the schedule or the request, a user may input the data by means of a specific ending designated in advance. According to one embodiment of the present invention, the user may determine if data correspond to the schedule or the request by itself the moment the data are input, and add a schedule identifier or a request identifier to the input data. For example, at the moment that voice or message data are received from a communication partner, a user determines if the corresponding data relate to a schedule or a request by itself and inputs a corresponding hot key, so that an identification bit or tag for identifying the schedule or the request may be added to the corresponding input data. This can improve the accuracy of data classification and enable data classification suitable to the situation to be performed.

According to another embodiment of the present invention, when data having an ending of “a request of ˜” are input from among information input from a user or other media (e.g., Internet), the data may be automatically classified into a request.

According to further another embodiment of the present invention, it is possible to distinguish a schedule from a request by comparing data stored in a database with input data. This is a more advanced method than the method for classifying data with a specific ending input by a user into a request. The database (schedule/request database) is stored in a user's individual apparatus together with the smart organizer, and provides a quick access for input data. Further, the database may be directly maintained by a user or maintained by a service provider through a network. The schedule/request database includes a schedule field and a request field. In each field, a word or a simple sentence, etc., for distinguishing the schedule field from the request field is stored as a field value. Otherwise, the schedule/request database may include only the request field, and a word or a simple sentence, etc. (for identifying a request from user input) is stored as a field value of the database. In this case, it is possible to identify only the request rather than both the schedule and the request, and the remainder is processed as the schedule.

As described above, the schedule/request database stores an ending of “a request of ˜” or a list of words such as “now,” “right now” and “here” in the request field.

In step 506, the data analyzer 312 performs a function extraction for the data classified into the schedule or the request. The function extraction represents determining a function necessary for action performance. In the present invention, the function extraction is performed with reference to words or simple sentences stored in a function extraction database similar to the schedule/request database. The function extraction database may be set by both a service provider and a user, storing words or simple sentences, etc., for extracting functions necessary for processing actions. For example, when input data correspond to text data of “select and display only a meeting from a given day's schedule,” the smart organizer detects the word “select” and determines that a function desired by the user is a “filtering function.”

Then in step 508, the data analyzer 312 performs a main element creation for the input data. In the main element creation, a main element has a form determined according to the extracted function (e.g., the filtering function). That is, the main element determined according to the input data through the main element creation process has a display portion which represents an action. For example, when a function is extracted by using the filtering function, a filtering object, an extracted word or sentence, a method for processing a filtering resultant, etc., may be a component of the main element.

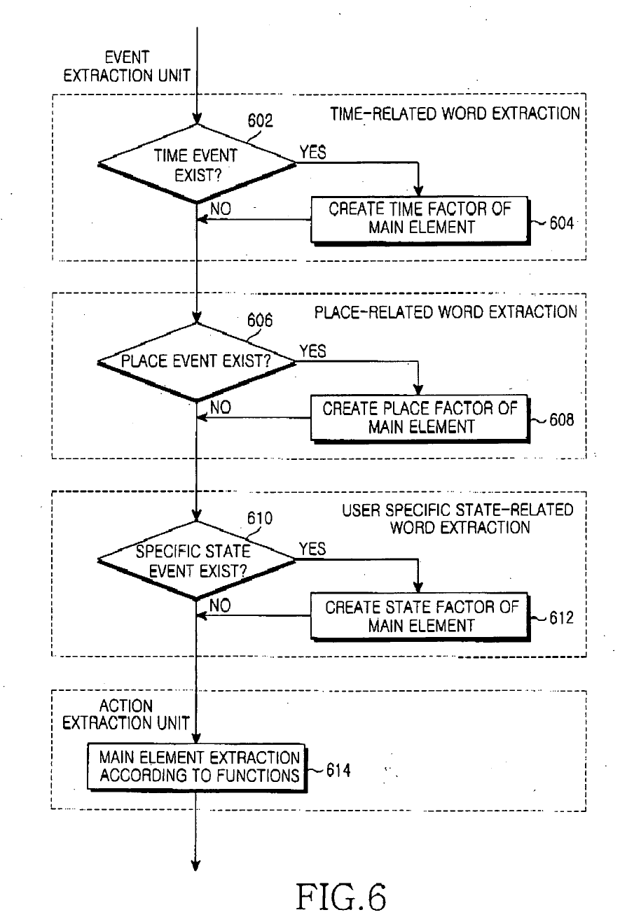

Then in step 510, the data analyzer 312 performs event or action extraction for the input data. The event or action extraction process will be described in more detail with reference to FIG. 6.

In step 512, the data classifier 322 detects the main element from the input data received from the data analyzer 312, and then classifies the input data into a schedule or a request. That is, when the specific field of the determined main element has been recorded as the “schedule”, step 514 is performed. That is, the data classifier 322 stores the input data in the user database. However, when the specific field of the determined main element has been recorded as the “request”, step 516 is performed.

Steps 516, 518, 520, 522 and 524 represent an operation procedure performed by the execution unit 304. In step 516, the execution classification unit 314 of the execution unit 304 recognizes the main element of the input data received from the data classifier 322 of the input unit 302. When the main element requires performance of a specific function, the execution classification unit 314 outputs the input data to the function performance units 324, 334 or 344 which will perform the corresponding function, and performs at least one of steps 518, 520 and 522. That is, the execution classification unit 314 outputs the input data to the corresponding performance unit so that the corresponding function performance unit can perform the corresponding function based on the field information recorded in the main element according to each function. The function performance unit capable of performing the corresponding function in at least one of steps 518, 520 and 522 performs the corresponding function. In step 524, the result summarizer 354 summarizes results of functions having been performed or which are to be performed by the function performance units. Then, step 526 is performed.

Step 526 represents an operation performed by the output unit 306. In step 526, the output unit 306 determines the execution means for optimally displaying resultants received from the result summarizer 354, and outputs the determined result to the display unit of the user terminal equipped with the smart organizer.

FIG. 6 is a flow diagram illustrating a process in which the event/action extraction unit processes input data according to a preferred embodiment of the present invention. The event/action extraction unit performs a word extraction process relating to time, a word extraction process relating to place, and a word extraction process relating to specific states of a user, for input data. The event extraction process as described above may be performed in a different sequence according to a given implementation method. For example, the event/action extraction unit may extract an event in a sequence of a word extraction relating to place, a word extraction relating to time and a word extraction relating to specific states, and set each event field of a main element.

Referring to FIG. 6, in step 602, the event/action extraction unit compares input data with a list of time event words stored in advance, and determines if a time event factor exists in the input data. As a result of this determination, when the time event factor exists in the input data, step 604 is performed. However, when the time event factor does not exist in the input data, step 606 is performed. Herein, the determination regarding whether a specific event factor exists in the input data is performed by checking if a word (coinciding with a predetermined word of the list stored in advance) exists in the input data. It is assumed that the list of time-event words stored in advance is stored in a time database.

The time database is similar to the previously described schedule/request database and is stored in the smart organizer. Further, a database storage list setup may be performed by a service provider and a user. The storage list may include various factors such as specific words, sentences, etc. For example, the event/action extraction unit detects a time expression pattern of “‘xx’ time on ‘mm’ month ‘dd’ date, ‘yyyy’ year” from data input of “meeting appointment with assistant manager Mr. Kim at 16:00 on Oct. 27, 2004,” and extracts a corresponding word as a main element. The list which may be stored in the time database includes texts of “morning,” “afternoon,” “tomorrow,” “after ˜,” “before ˜,” etc., as well as date and time.

As described above, when a time-related event factor is input, a user may input the words, sentences, etc., which are commonly used by the user, in advance to the time database as an additional field value. Further, the user may also receive a database update regularly or irregularly from a service provider for providing a smart schedule management service.

In step 604, the event/action extraction unit outputs the extracted time event factor to a main element creator. In step 606, the event/action extraction unit compares the input data with a list of place-event words stored in advance, and determines if a place-event factor exists in the input data. As a result of this determination, when the place event factor exists in the input data, step 608 is performed. Otherwise, step 610 is performed. Herein, the determination regarding whether a specific event factor exists in the input data is performed by checking if a word coinciding with a predetermined word of the list stored in advance exists in the input data. It is assumed that the list of place-event words stored in advance is stored in a place database.

The place database is also stored in the smart organizer, which represents a list storing words or sentences relating to factors for place and may be set by a service provider and a user. For example, when data of “call A upon arriving at home” are input to the event/action extraction unit, the event/action extraction unit extracts a word of “home” from the list stored in the place database. That is, the place database may store event factors relating to place such as “home,” “office,” “front of department store,” “dining room” and “sports center”. This is similar to a method for inputting the list of time-event words to the time database. That is, in a place-related event list input, a user may input words commonly used by the user to the place database, and a service provider for providing a smart schedule management service may upgrade related patterns in the database. The data input to the event/action extraction unit may be input directly or indirectly by a user, but it may be data according from other sources (e.g., e-mails, text messages). That is, when the place-related event factor exists in the e-mails or the text messages, the event/action extraction unit extracts the event, thereby setting a place factor of a main element.

In step 608, the event/action extraction unit outputs the extracted place event factor to the main element creator. In step 610, the event/action extraction unit determines if a word relating to a user specific state can be extracted from the input data. As a result of this determination, when the word can be extracted from the input data, step 612 is performed. Otherwise, step 614 is performed. In step 612, the event/action extraction unit outputs the extracted specific state event factor to the main element creator. Then, step 614 is performed.

A specific state database is very similar to the previously described time database and place database. That is, the specific state database stores a list of specific state-event words. The specific state database is also stored in the smart organizer and its list setup may be performed by a service provider and a user. For example, when data of “output a given day's schedule by voice during driving” are input, the event/action extraction unit outputs the sentence “during driving” as the specific state-event factor. Since the sentence “during driving” is already stored in the specific state database as a list, it may be extracted. In addition, the specific state database may store words or simple sentences such as “busy,” “in conference,” “away,” “sleep” and “during driving”. As described above, in a specific state list input, a user may store words commonly used by the user in the specific state database, and a service provider for providing a smart schedule management service may upgrade related patterns in the database. The upgrade includes an automatic upgrade through the Internet as described above and a manual upgrade directly performed by a service center.

In step 614, the event/action extraction unit extracts an action factor according to the main element types determined by the main element creator. The event/action extraction unit has an action database used for extracting the action factor. The action database is stored in the smart organizer and setup for its list may be performed by a service provider and a user. The list includes words or simple sentences used for extracting the action factor according to each function. The input data output from the event/action extraction unit, using the event or action extraction process through steps 602, 604, 606, 608, 610, 612 and 614, have the main element formed according to the present invention.

The event/action extraction process as described in FIG. 6 may be performed in a different sequence according to a given implementation method of the smart organizer.

As described in FIG. 5, the smart organizer classifies the input data having passed through the event/action extraction process into either the request or the schedule. The main element of the input data classified into the schedule is stored in the user information database until a corresponding event occurs. The main element classified into the request is transferred to the execution unit 304 and the function performance unit performs the function classified by the function execution classification. The smart organizer having completed the classified function performs the resultant summarization process for summarizing the resultants obtained by completing the function execution. The resultants are transferred to the output unit 306. The output unit 306 selects an output unit suitable for the resultants, thereby displaying the input data execution result to a user.

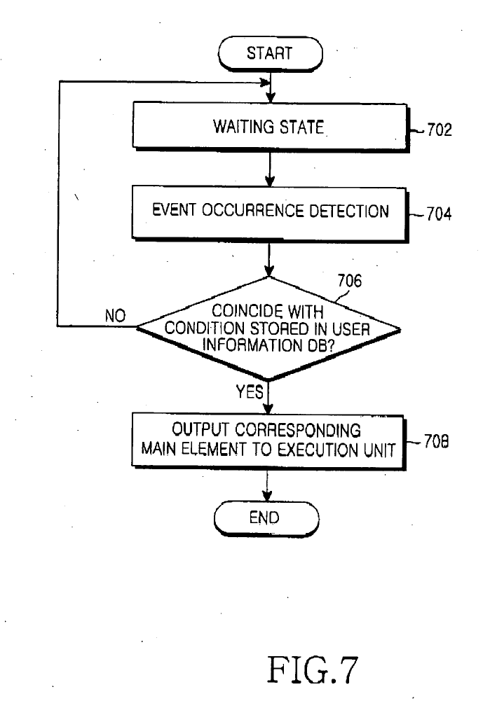

FIG. 7 is a flow diagram illustrating a processing procedure when an event occurs in a schedule according to the embodiment of the present invention. Referring to FIG. 7, in step 702, the event processor in a waiting state communicates with the user information database. In step 704, when the event processor detects the occurrence of a specific event of the stored schedules while communicating with the user information database, the event processor determines if the specific event coincides with an event factor of a main element. Then, step 706 is performed. When the occurring event coincides with the stored event factor, the event processor outputs a corresponding main element stored in the user information database to the execution unit 304 in step 708.

FIG. 8 is a diagram illustrating the structure of the main element according to the embodiment of the present invention. Referring to FIG. 8, the main element may include an input time field 802 representing the input time of input data, a schedule/request classification field 804, a determined function field 806 representing functions determined according to results of the function extractor, a target time field 808, a target place field 810 and a target state field 812 of a corresponding event, and action factor fields 814, 816 and 818 which correspond to the result of the action extractor. The fields 808, 810 and 812 correspond to the result of the event extractor. The target time field 808 of the fields in the main element denotes the time at which an action is to be executed. The target place field 810 denotes the place at which the action is to be executed. The target state field 812 denotes a specific state when a user desires execution of the action.

Hereinafter, a process by which various types of data are input and processed will be described in detail. As described above, data may include images, audio, text, etc. The smart organizer may receive various types of data from a user (realtime) or an outside source.

First, a case where the user directly inputs texts of various data to the smart organizer will be described. The user inputs a schedule or a request in a text form by using an input means for a terminal incorporating the smart organizer. Preferably, the user may also input a schedule identifier or a request identifier by using a function key or a hot key of the terminal, and input the contents of the corresponding schedule or request in the text form by means of voice or a key pad.

The input data, including the text, are stored in corresponding databases at the moment the data are input or stored in the corresponding databases through analysis and classification processes after the data are completely input. Otherwise, the data are input to the execution unit for execution of a specific function.

Audio input data are converted into text and stored in corresponding databases through analysis and classification processes, or are input to the execution unit for execution of a specific function. Further, image input data may be classified into either a dynamic image or a still image. Most dynamic images include audio data, the audio data includes most main elements, and an image includes location information. The smart organizer can extract most of the main elements from the audio factor of the dynamic image and can also extract the location information from the image factor according to implementation methods or setup methods. Likewise, most still images also include location information. In this case, the smart organizer can acquire location information of a corresponding image by using a GPS, etc., at a time point at which a user inputs the image.

The case where external data are input employs a scheme equivalent to that for the case where the user directly inputs the data.

In the smart organizer, a schedule management function can be turned on or off according to a user selection. Further, the smart organizer may be executed in a specific terminal by itself. However, because the smart organizer may coexist with other services, it is preferred that it is realized as a menu of a user terminal.

According to the present invention as described above, a smart organizer receives various types of data, thereby performing a schedule management function through an automatic analysis. Further, the smart organizer can also process an event factor such as place and a user specific state, as well as a schedule based on date and time. Consequently, a user can efficiently manage its own schedules and a service provider can provide various services.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for managing user schedules, the method comprising the steps of:
inputting data;
determining if the input data correspond to at least one of schedule data and request data;
extracting a function necessary for executing an action which a user must perform for at least one of the schedule data and the request data at a specific time point;
determining a main element type according to the extracted function; and
storing the input data when the input data corresponds to the schedule data according to the determined main element type, and executing the extracted function and outputting results obtained by executing the extracted function when the input data correspond to the request data.

2. The method as claimed in claim 1, wherein the data is at least one of input by user input through a user organizer and received from an external communication network.

3. The method as claimed in claim 2, wherein, an identifier for identifying at least one of the schedule data and the request data is added to the data by the user, and the input data is classified into one of a schedule and a request.

4. The method as claimed in claim 2, wherein, when the data received from at least one of the user and the external communication network include a specific ending, the input data is classified into one of a schedule and a request based on a specific preset ending classification criterion.

5. The method as claimed in claim 1, wherein the main element type includes at least one of a data input time field, a schedule/request classification field expressed as a schedule or a request, a determined function field for determining functions to be executed according the data input, event factor fields, and action factors fields.

6. The method as claimed in claim 5, wherein the event factor fields include one of target time, target place and target state factors which represent corresponding event information.

7. The method as claimed in claim 6, wherein, when at least one coincident event factor exists in the event factors as a result of searching for current time and place, occurrence of an event is reported to the user.

8. The method as claimed in claim 5, wherein the action factors correspond to action factors representing actions to be performed according to a corresponding event.

9. The method as claimed in claim 1, wherein the input data include one of image data, audio data and text data.

10. An apparatus for managing user schedules, the apparatus comprising:
an input unit for receiving data related to the user schedules, determining if the data corresponds to schedule data or request data, extracting a function necessary for executing an action which a user must perform at a specific time for the schedule data or the request data, determining a main element type according to the extracted function, storing the data when the input data correspond to the schedule data according to the main element type, and executing the extracted function and outputting the request data in order to execute the extracted function when the data correspond to the request data;
an execution unit for classifying functions according to a main element of the output request data, executing the classified functions, and outputting results obtained by executing the classified functions; and
an output unit for receiving the results from the execution unit and displaying the received results.

11. The apparatus as claimed in claim 10, wherein the input unit receives the data from at least one of the user and an external communication network.

12. The apparatus as claimed in claim 11, wherein, when the data received from at least one of the user and the external communication network include a specific ending, the input unit classifies the input data into one of a schedule and a request based on a specific preset ending classification criterion.

13. The apparatus as claimed in claim 11, wherein the input unit classifies the input data into one of a schedule and a request according to whether a specific word or sentence of the input data exists in a list of words or sentences, which are classified into one of the schedule and the request before being stored.

14. The apparatus as claimed in claim 10, wherein the input unit determines the main element type as at least one of an input time field, a schedule/request classification field, a determined function field, event factor fields, and action factors fields.

15. The apparatus as claimed in claim 14, wherein the action factor fields correspond to action factors representing actions to be performed according to a corresponding event.

16. The apparatus as claimed in claim 14, wherein the event factor fields correspond to target time, target place and target state factors which represent corresponding event information.

17. The apparatus as claimed in claim 10, wherein, when at least one coincident event factor exists in the schedule data stored as the main element type as a result of searching for current time and place, occurrence of an event is reported to the user.

18. The apparatus as claimed in claim 10, wherein the input data include one of image data, audio data and text data.
